(19) United States
(12) Patent Application Publication
(10) Pub. No.: US 2020/0017034 A1
(43) Pub. Date: Jan. 16, 2020

(54) VEHICULAR MOBILE DEVICE HOLDER AND CHARGER

(71) Applicant: John Litterello, Melbourne, FL (US)

(72) Inventor: John Litterello, Melbourne, FL (US)

(21) Appl. No.: 16/509,676

(22) Filed: Jul. 12, 2019

Related U.S. Application Data
(60) Provisional application No. 62/698,708, filed on Jul. 16, 2018.

(51) Int. Cl. B60R 11/02; H02J 7/02

(52) U.S. Cl. CPC B60R 11/0241; B60R 2011/0007; H02J 7/025

(57) ABSTRACT

A vehicular mobile device holder is provided. The vehicular mobile device holder includes a base the extends from a planar proximal end to a planar distal end, wherein the base simultaneously spirals about a longitudinal axis and a latitudinal axis as it extends therebetween. As a result, the planar distal end is oriented at an angle of inclination relative to planar proximal end of approximately sixty-five to eighty degrees relative to the longitudinal axis. The proximal end provides a flange to wrap around the console of the vehicle and secure the base thereto. The distal end faces the driver and provides a charging pad and peripheral guides to charge and retain a mobile device respectively.

### CROSS-REFERENCE TO RELATED APPLICATION

This application claims the benefit of priority of U.S. provisional application No. 62/698,708, filed 16 Jul. 2018, the contents of which are herein incorporated by reference.

### BACKGROUND OF THE INVENTION

The present invention relates to mobile device holders and, more particularly, to a vehicular mobile device holder and charger specifically designed for a Corvette C7 so as to mold to and match the interior dash thereof.

The Corvette C7 is a two-seat sports car with a powerful V-8 engine under the hood. As a result, there are is not much room for peripherals or accessories; specifically, there is no ability to locate and charge a mobile device in a C7 Corvette in a position that is viewable and accessible by the driver.

Makeshift solutions are an aesthetic distraction, do not support wireless charging, are unstable, and tend to let the device fall out while accelerating and turning, or require the driver to lose a cup holder.

As can be seen, there is a need for a mobile device holder and charger specifically designed for a Corvette C7 or similar confined-space vehicles so as to mold to and match the interior dash thereof.

The device embodied in the present invention works in conjunction with the hands-free system of the Corvette C7 and places the mobile device in a perfect location to minimize the time to view. The present invention will also charge (wired or wireless) the mobile phone or smart device and not distract the driver from the view of the road.

The holder device is dimensioned and specifically designed to slide onto the existing power receptacle in an open position on the center console of the automobile with the face of the product towards the driver. A single flange of the unit also wraps around the console structure to provide a stable position and limit any movement of the device. The mobile device is placed in a position within the fixed protruded guides to the left, bottom and right of the face of the molded structure. The molded structure is in an orientation that is slanted back at an angle towards the driver and designed to support the mobile device without sliding out of position when turning or accelerating while simultaneously charging the phone either through a wire or wirelessly. The present invention is aesthetically integrated with the center console and dash panel.

### SUMMARY OF THE INVENTION

In one aspect of the present invention a vehicular mobile device holder includes the following: a base the extends between a planar proximal end and a planar distal end, wherein the base simultaneously spirals about a longitudinal axis and a latitudinal axis as it extends therebetween, and wherein the planar distal end is oriented at an angle of inclination relative to planar proximal end of approximately sixty-five to eighty degrees relative to the longitudinal axis.

In another aspect of the present invention, a Corvette C7 mobile device holder includes the following: a base the extends between a planar proximal end and a planar distal end, wherein the base simultaneously spirals about a longitudinal axis and a latitudinal axis as it extends therebetween, and wherein the planar distal end is oriented at an angle of inclination relative to planar proximal end of approximately sixty-five to eighty degrees relative to the longitudinal axis; a flange provided along the planar proximal end for engaging a console the Corvette C7; a charging pad disposed the planar distal end; a protruded guide disposed along a majority of a periphery of the planar distal end; and a connector hole in the base for operatively associating a connector to the console through the connector hole.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a top plan view of an exemplary embodiment of the present invention;

FIG. 3 is a front elevation view of an exemplary embodiment of the present invention;

FIG. 4 is a side elevation view of an exemplary embodiment of the present invention;

FIG. 5 is a side elevation view of an exemplary embodiment of the present invention;

FIG. 6 is a cross-section view of an exemplary embodiment of the present invention; and

FIG. 7 is a perspective view of an exemplary embodiment of the present invention shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a vehicular mobile device holder providing a base the extends from a planar proximal end to a planar distal end, wherein the base simultaneously spirals about a longitudinal axis and a latitudinal axis as it extends therebetween. As a result, the planar distal end is oriented at an angle of inclination relative to planar proximal end of approximately sixty-five to eighty degrees relative to the longitudinal axis. The proximal end provides a flange to wrap around the console of the vehicle and secure the base thereto. The distal end faces the driver and provides a charging pad and peripheral guides to charge and retain a mobile device respectively.

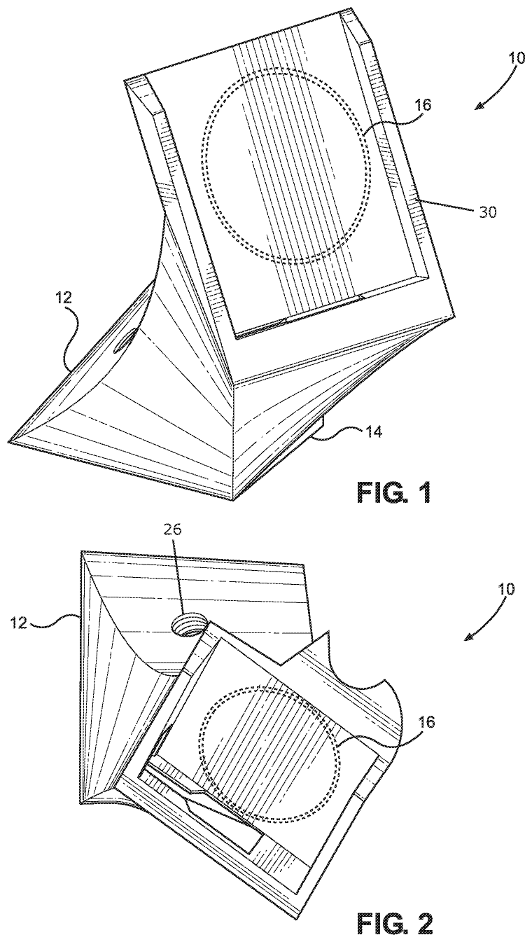

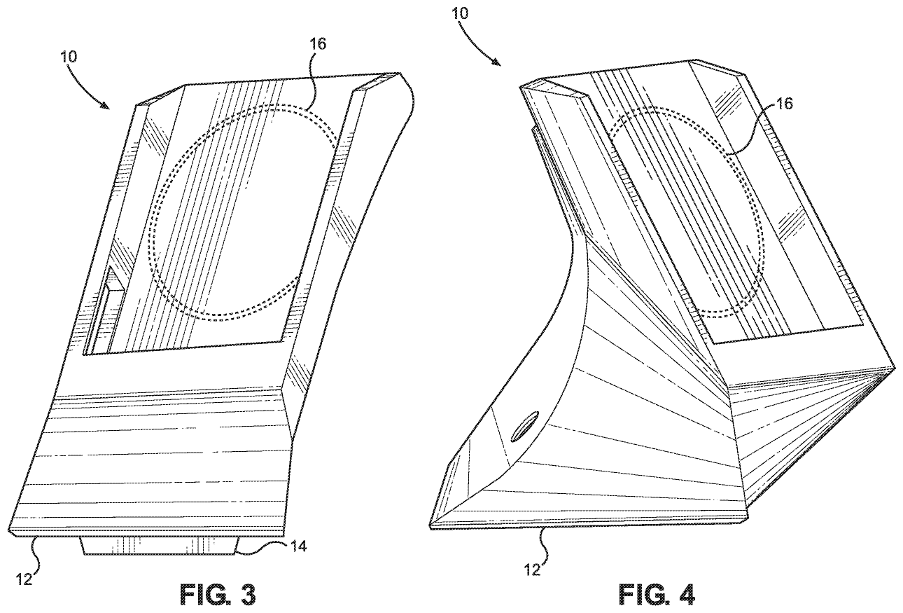

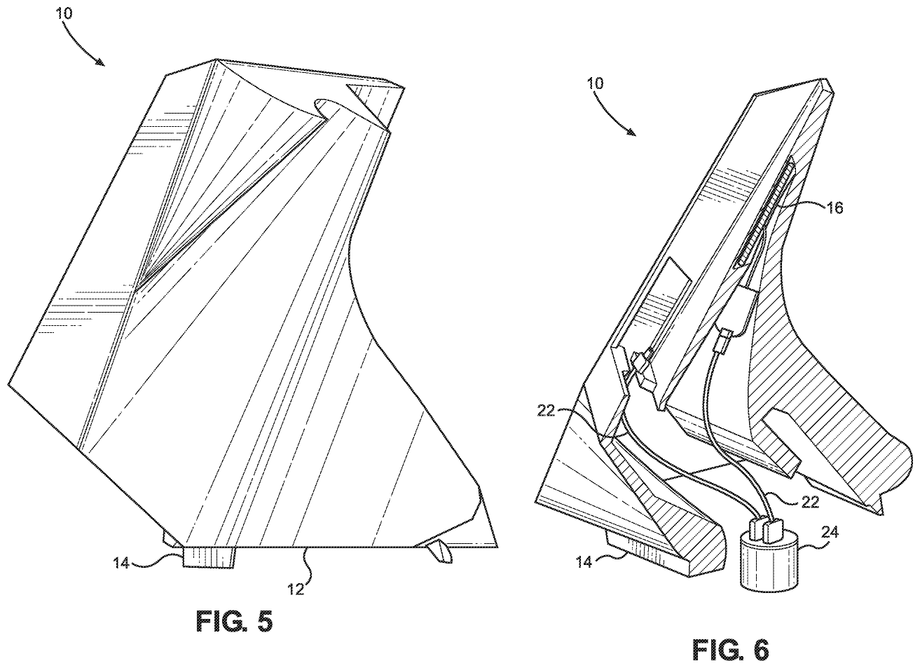

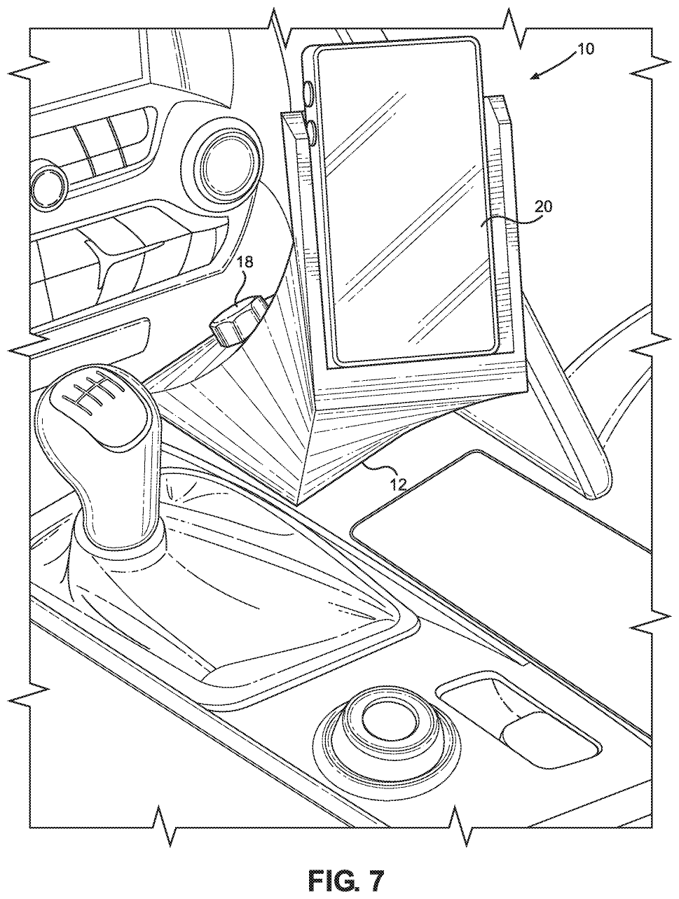

Referring to FIGS. 1 through 7, the present invention may include a vehicular mobile device holder 10 adapted to mold to and match the interior dash of a vehicle. The vehicular mobile device holder 10 may include a systemic base 12 and one or more systemic connectors 18 for connecting the vehicular mobile device holder 10 the vehicle through a connector hole 26. Both the systemic base 12 and the systemic connector 18 may be made from 3D printed PETG plastic filament or the like.

It should be understood by those skilled in the art that the use of directional terms such as upper, lower, upward, downwardly, top and the like are used in relation to the illustrative embodiments as they are depicted in the figures, the upward (or upper) direction being toward the top of the corresponding FIGS. and a downward (or lower) direction being toward the bottom of the corresponding FIGS.

The systemic base 12 may extend from a proximal end to a distal end, wherein the proximal and distal ends may be generally planar though oriented along (proximal and distal) planes that are transverse relative to each other. In certain embodiments, the distal plane may be approximately orthogonal relative to each other. The systemic base 12 may extend in a tortuous manner from the proximal end to the distal end; specifically, the systemic base 12 may so extend in a spiral manner about a longitudinal axis and simultaneously about a latitudinal axis orthogonal to the longitudinal axis, as illustrated in FIGS. 1, 4, and 7. The proximal end may provide a flange 14 for operatively associating with the vehicle.

A wireless charging pad 16 may be provided by the distal end. Protruded guides 30 may be disposed along a periphery of the charging pad 16 for supporting the mobile device 20. The charging pad 16 may be electrically coupled by way of an electrical connection 22 to a dual accessory connection 24 or directly to the mobile device 20. The dual accessory connection 24 may be a USB car charger cigarette lighter adapted to operatively associate with the vehicle's cigarette lighter. The electrical connection 22 may be USB charging cables of the like

The present invention is specifically designed to work in conjunction with the hands-free system of a C7 Corvette, creating the ability to locate and charge (wired or wireless) a mobile device 20 in a position that is viewable and accessible.

The vehicular mobile device holder 10 is dimensioned and specifically designed to slide onto the existing power receptacle in an open position on the center console of the vehicle with the distal end facing the driver. The flange 14 wraps around the console structure to provide a stable position and limit any movement of the vehicular mobile device holder 10. The mobile device 20 is placed in a position within the protruded guides 30 to the left, bottom and right of the face of the molded structure.

The molded structure of the systemic base 12 may be in an orientation that is slanted back at an angle towards the driver and designed to support the mobile device 20 without sliding out of position when turning or accelerating. In other words, the present invention is cosmetically integrated with the center console and dash panel. With the mobile device 20 maintained in a stable, viewable position the driver of the vehicle does not have to take eyes off the road or hands off the steering wheel to use the mobile device 20.

It should be understood that even though the present invention is specifically designed for a Corvette C7 it may be adapted for other vehicles affording limited space adjacent to the driver, including but not limited to other sport cars.

It should be understood, of course, that the foregoing relates to exemplary embodiments of the invention and that modifications may be made without departing from the spirit and scope of the invention as set forth in the following claims.

What is claimed is:

1. A vehicular mobile device holder, comprising:
a base the extends between a planar proximal end and a planar distal end, wherein the base simultaneously spirals about a longitudinal axis and a latitudinal axis as it extends therebetween, and wherein the planar distal end is oriented at an angle of inclination relative to planar proximal end of approximately sixty-five to eighty degrees relative to the longitudinal axis.

2. The vehicular mobile device holder of claim 1, further comprising:
a flange provided along the planar proximal end for engaging a console of a vehicle.

3. The vehicular mobile device holder of claim 1, further comprising:
a charging pad disposed the planar distal end.

4. The vehicular mobile device holder of claim 1, further comprising:
a protruded guide disposed along a majority of a periphery of the planar distal end.

5. The vehicular mobile device holder of claim 2, further comprising:
a connector hole in the base for operatively associating a connector to the console through the connector hole.

6. The vehicular mobile device holder of claim 2, wherein the vehicle is a Corvette C7.

7. A Corvette C7 mobile device holder, comprising:
a base the extends between a planar proximal end and a planar distal end, wherein the base simultaneously spirals about a longitudinal axis and a latitudinal axis as it extends therebetween, and wherein the planar distal end is oriented at an angle of inclination relative to planar proximal end of approximately sixty-five to eighty degrees relative to the longitudinal axis;
a flange provided along the planar proximal end for engaging a console the Corvette C7;
a charging pad disposed the planar distal end;
a protruded guide disposed along a majority of a periphery of the planar distal end; and
a connector hole in the base for operatively associating a connector to the console through the connector hole.
